(19) United States
(12) Patent Application Publication
(10) Pub. No.: US 2003/0057066 A1
(43) Pub. Date: Mar. 27, 2003

(54) Switch

(76) Inventor: Hubert Laurenz Naimer, Ascona (CH)

Correspondence Address: Collard & Roe, 1077 Northern Boulevard, Roslyn, NY, 11576, US

(21) Appl. No.: 10/221,533

(22) PCT Filed: Jan. 30, 2001
(86) PCT No.: PCT/AT01/00023

(51) Int. Cl. H01H 9/20

(52) U.S. Cl. 200/50.01

(57) ABSTRACT

A combination of a switch which is controllable via a grip (5) and comprises a receiving means for fuses (4) in which the fuses (4) are held in a swivelable flap (2), with a switch (1) being provided on the mains side of the receiving means for the fuses (4) which is covered by a housing (9) and the flap (2) which is provided for receiving the fuses (4) is locked with the grip (5) of the switch (1) in its closed switching position. In order to provide a simple arrangement it is provided that the grip (5) of the switch (1) is held in the flap (2) of the receiving means for the fuses (4), with the grip (5) being insertable on an actuating shaft (11) of the switch (1) merely in its opened position.

The invention relates to a combination according to the preamble of claim 1.

Such combinations are usually provided in order to enable the breaking of the electric circuit before the fuses in the case of the necessity to exchange such fuses. The fuses are constructed with a relatively small size and are provided with electrically conducting caps extending on either side over the jacket surface of said fuses, which caps rests on contact surfaces in the closed state of the receiving means.

In known such combinations, when the fuses are inserted, the receiving means for the fuses usually assume the function of a switch or disconnector when fuses are inserted. In the closed position of the disconnector the fuses cooperate with contacts on the mains side. This leads to the disadvantage that a respective shock-hazard protection of the contacts on the mains side can only be achieved by a relatively complex mechanism in the opened state of the combination or the fixing device for the fuses.

A further disadvantage is also given by the fact that during the opening of the fuses under load an arc is produced.

It is therefore the object of the present invention to avoid this disadvantage and to provide a combination of the kind mentioned above which is characterized by a simple arrangement.

This is achieved in accordance with the invention in a combination of the kind mentioned above by the characterizing features of claim 1.

The proposed measures ensure that an exchange of fuses is only possible when the switch is in its off position. Since the switch itself is provided with a respective housing, a secure shock-hazard protection is ensured. The shock-hazard protection is achieved in a very simple manner, namely by the arrangement of the switch.

The features of claim 2 lead to the advantage of a solution which is very simple in a constructional respect. The grip held in the flap can only be uncoupled from the switch in the position corresponding to the opened position of the switch, which is necessary for opening the flap receiving the fuses. Since the grip is an integral part of the flap, the switch cannot be actuated when the flap is opened and when the fuses are accessible. This ensures that the fuses are exchanged always in the no-load state and the switch can only be actuated when the flap is closed.

It is especially advantageous to provide the features of claim 2.

The features of claim 4 can be provided. The grip is appropriately arranged as a toggle.

The invention is now explained in closer detail by reference to the enclosed drawing, wherein:

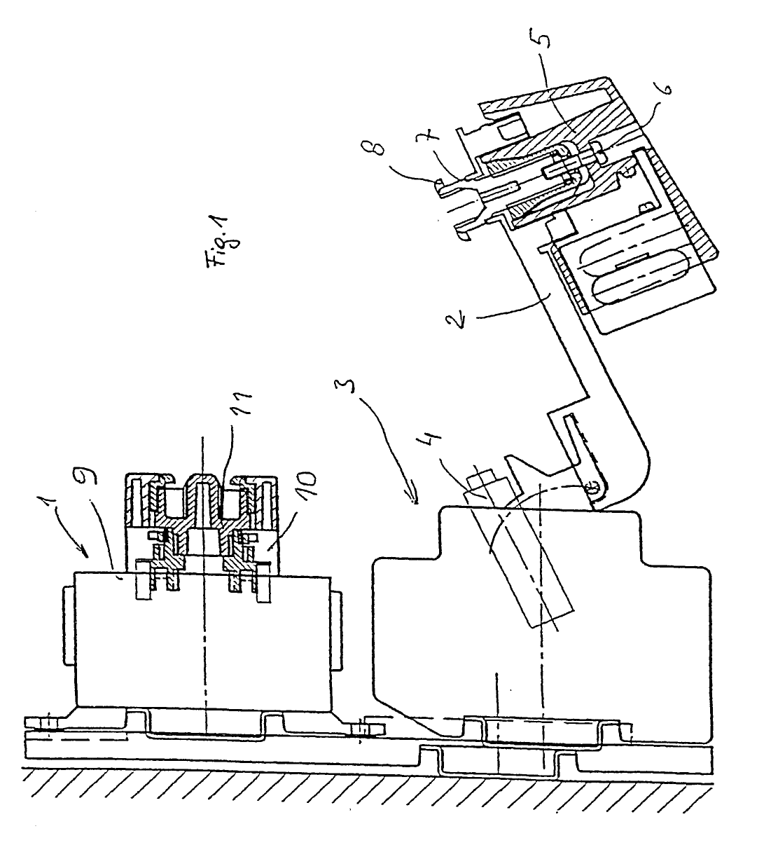

FIG. 1 schematically shows a combination in accordance with the invention with opened receiving means of the fuses;

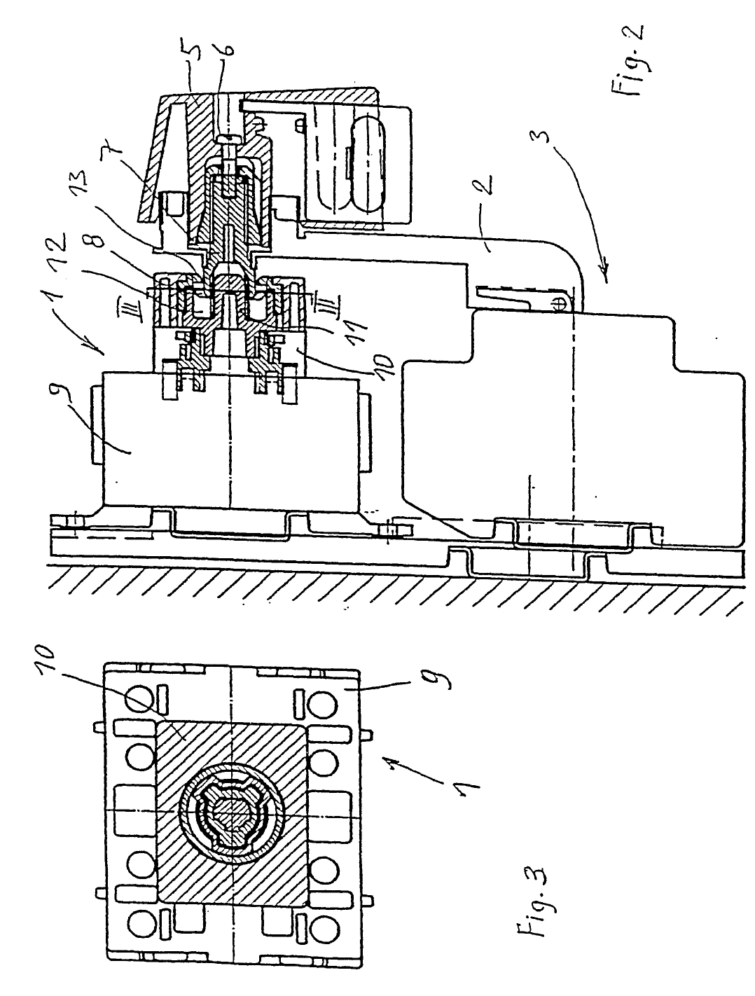

FIG. 2 shows the combination in the closed state;

FIG. 3 shows a sectional view through a part of the combination along line III-III in FIG. 2, and

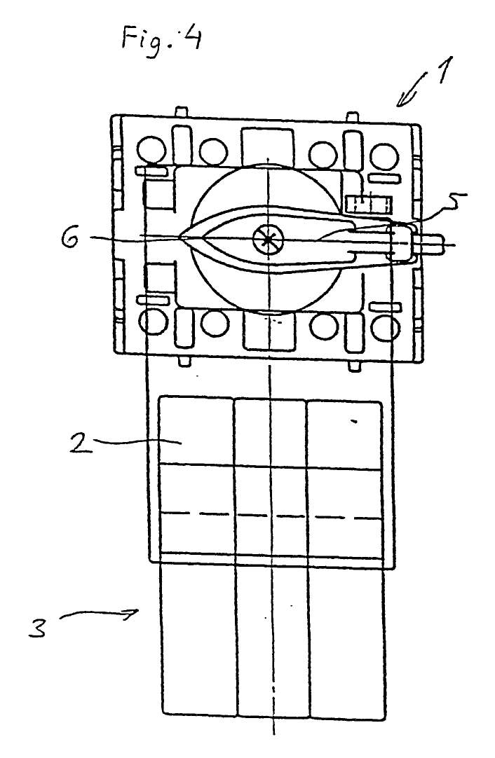

FIG. 4 shows a view of the combination when the switch is opened.

The combination according to FIG. 1 comprises a switch 1 which is arranged on the mains side on a fixing device 3 for fuses 4, which fixing device comprises a flap 2.

A grip 5 is rotatably held in the flap 2, which grip is connected with a hollow shaft 7 by means of a screw 6, which shaft is provided in the zone of its free end in sections with outwardly facing flange-like projections 8.

Switch 1 is provided with a housing 9 which is provided with a fore-part 10 in which an actuating shaft 11 is held rotatably.

As can be seen from FIG. 2, the flap 2 can be swiveled upwardly, with the hollow shaft 7 of grip 5 being inserted on the actuating shaft 11.

This is only possible, however, when the actuating shaft 11 is situated in a position corresponding to the opened switch 9 and the grip 5 is held in a position corresponding to the opened position of switch 9.

The edge of the fore-part 10 of housing 9 of switch 1, which edge delimits an opening 12 which encloses the free end of the actuating shaft 11, is provided with sections 13 which are undercut over sections. The flange-like projections 8 of the hollow shaft 7 can be inserted into the intermediate spaces between the undercut zones 13 of the edge of opening 12 when the grip is situated in the opened position of switch 1. This allows a coupling of the grip 5 with the actuating shaft 11 under the condition that the actuating shaft 11 is situated in the position corresponding to the opened switching state of switch 1.

If the grip 5 is twisted thereafter and thus the switch 1 is closed, the flange-like projections 8 of the hollow shaft 7 of the grip 5 grasp behind the undercut zones 13 of the fore-part 10 of housing 9 of the switch, so that the flap 2 can no longer be flipped open. This ensures, that the same cannot be opened when switch 1 is closed.

1. A combination of a switch which is controllable via a grip (5) and comprises a receiving means for fuses (4) in which the fuses (4) are held in a swivelable flap (2), characterized in that a switch (1) covered by a housing (9) is provided on the mains side of the receiving means for the fuses (4) and the flap (2) provided for receiving the fuses (4) is locked with the grip (5) of the switch (1) in its closed switching position.

2. A combination as claimed in claim 1, characterized in that the grip (5) of the switch (1) is held in the flap (2) of the receiving means for the fuses (4), with the grip (5) being insertable on an actuating shaft (11) of the switch (1) merely in its opened position.

3. A combination as claimed in claim 1 or 2, characterized in that the grip (5) comprises a profiled hollow shaft (7) which comprises in the zone of its free end outwardly facing flange-like sections (8) which can be inserted between undercut zones (13) of the edge of an opening (12) of the housing (9) of the switch (1) for receiving the grip (5).

4. A combination as claimed in claim 1, characterized in that the grip (5) of the switch (1) overlaps the free edge of the flap (2) for receiving the fuses (4) in the position corresponding to the closed switch.
